(19) United States
(12) Patent Application Publication
(10) Pub. No.: US 2020/0385526 A1
(43) Pub. Date: Dec. 10, 2020

(54) WATER VAPOR STERILIZABLE TRANSPARENT BARRIER LAYERS PREVENTING OXYGEN TRANSMISSION FOR PACKAGING MATERIALS

(71) Applicant: Evonik Operations GmbH, Essen (DE)

(72) Inventors: Vadym Bakumov, Marl (DE); Maik Dimmerling, Oer-Erkenschwick (DE); Helmut Mack, Traunstein (DE); Thomas Pastor, Dülmen (DE); Katrin Renger, Lörrach (DE); Marie-Theres Wilkes, Dorsten (DE); Odo Wunnicke, Münster (DE)

(73) Assignee: Evonik Operations GmbH, Essen (DE)

(21) Appl. No.: 16/767,205

(22) PCT Filed: Dec. 5, 2018
(86) PCT No.: PCT/EP2018/083572

§ 371 Date: May 27, 2020

(30) Foreign Application Priority Data
Dec. 6, 2017 (EP) 17205657.4

(51) Int. Cl. C08G 77/04; C09D 183/04

(52) U.S. Cl. CPC C08G 77/04; C09D 183/04

(57) ABSTRACT

The present invention relates to a formulation comprising: i) at least one hydrolysate of at least one compound of formula (I) RSi(OX)₃ (I) where X, the same or different, is H, C₁-C₄ alkyl or acyl, R=OX, OH, C1-C4 alkyl or alkoxy silyl-substituted ethylene radical, ii) at least one hydrolysate of at least one polyisocyanurate bearing alkoxy silyl alkyl units, iii) at least one polymer bearing hydroxyl groups, and iv) a solvent mixture containing water comprising at least one alcohol with 1 to 4 carbon atoms, wherein the pH value of the formulation lies in a range from 1.8-4.7, preferably from 3-4.5, and the content of the polymer bearing hydroxyl groups ranges from 13 wt. % to 33 wt. % related to the solids content in the formulation. The invention further relates to a method for the production of said formulation, the use thereof in the production of laminate structures and corresponding laminate structures having at least two layers comprising the formulation.

### CROSS REFERENCE TO RELATED APPLICATIONS

This application is a 35 U.S.C. § 371 U.S. national phase entry of International Application No. PCT/EP2018/083572 having an international filing date of Dec. 5, 2018, which claims the benefit of European Application No. 17205657.4 filed Dec. 6, 2017, each of which is incorporated herein by reference in its entirety.

### FIELD

The present invention relates to a formulation comprising:

i) at least one hydrolysate of at least one compound of the formula (I)

RSi(OX)₃ (I)

where X are the same or different and are H, C₁-C₄-alkyl or acyl, R=OX, OH, C₁-C₄-alkyl or alkoxysilyl-substituted ethylene radical,

ii) at least one hydrolysate of at least one polyisocyanurate bearing alkoxysilylalkyl units,

iii) at least one polymer bearing hydroxyl groups, and

iv) an aqueous solvent mixture containing at least one alcohol having 1 to 4 carbon atoms,

wherein the pH of the formulation is within a range from 1.8-4.7, preferably from 3-4.5, and the content of the polymer bearing hydroxyl groups is from 13% by weight to 33% by weight, based on the solids fraction of the formulation, to a process for the preparation thereof, to the use thereof for the production of laminate structures and to corresponding laminate structures having at least 2 layers comprising the formulation.

### BACKGROUND

Oxygen in the air is one of the causes and a prerequisite for the spoilage of, for example, foodstuffs, electronics products or pharmaceutical products during transport and storage. In many cases, the spoilage results from the growth of pathogenic bacteria or fungi on foodstuffs and also from the oxidation of the essential ingredients. Therefore, what is striven for is to keep oxygen away from a multiplicity of foodstuff products, electronics products and pharmaceutical products by means of airtight packaging.

Polymers or plastics such as, for example, polyesters, especially polyethylene terephthalate (PET), are preferred as packaging materials to alternatives composed of metal or glass because of their see-throughness or optical transparency, their low weight and their mechanical stability. The commercially available light transparent PET plastics films only provide limited protection against the inward diffusion or the transmission of oxygen through said film into the foodstuff or medicament packaging. The typical permeability or transmission of the 12 to 125 micrometer thick plastics films for oxygen is within the range from 5 to 500 cm³/m²/g/d/atm. Such permeability—also referred to as transmission rate—greatly limits the shelf life and, associated therewith, the usability of said packaged products, for example foodstuffs or medicaments.

To prolong the shelf life and usability of the packaged products, it is known in the prior art that plastics are coated as films and thus form a laminate structure or a laminate. For coating of these plastics films and for the construction of a laminate structure, polymers, for example polyvinyl dichloride (PVDC), ethylene vinyl alcohol (EVOH) or polyvinyl alcohol (PVOH), as well as inorganic oxide compounds, for example silicon oxide or aluminium oxide compounds, are known in the prior art. Owing to their property of reducing the transmission or the inward diffusion of oxygen, these materials are also referred to as barrier materials. The coating of plastics films with one or more barrier materials forms barrier layers, which lead to a laminate structure, which lower the permeability or transmission for oxygen in comparison with an uncoated plastics film.

When using polyvinyl dichloride (PVDC), a disadvantage is the disposal of the laminate film after its use. Ethylene vinyl alcohol (EVOH) and polyvinyl alcohol (PVOH) lose, at least partially, their barrier action with respect to oxygen in the presence of high moisture, typically at >70% relative air humidity. In particular, the rise in oxygen permeability and thus the loss of the barrier action of PVOH- and EVOH-containing packaging materials after the treatment with hot water vapor becomes noticeable at 99° C. and 98% relative air humidity over 16 h. Such treatment with water vapor is standard in the food industry for the purposes of sterilization (killing of pathogens) and is carried out before and, in particular, after the packaging of the product. This sterilization with hot water vapor is known in the prior art as “retorting” or “retort treatment”.

### SUMMARY

U.S. Pat. No. 7,531,243 B2 thus discloses the production of transparent barrier layers comprising phyllosilicates against oxygen transmission that maintain their barrier action even under high air humidity. Production is carried out on the basis of the sol-gel method using polymers which have hydroxyl groups and react to completion by means of condensation reactions. The polymer used is PVOH. As sol-gel method, the hydrolysis of alkoxysilanes with hydrochloric acid at low pH levels, i.e. pH<2, is employed.

### DETAILED DESCRIPTION

U.S. Pat. No. 7,157,147 B2 discloses the production of transparent barrier layers against oxygen transmission which, even after 30 min of treatment with hot water at 90° C., maintain an oxygen transmission rate of 1 g/m²/d/atm. Production is carried out from phyllosilicates, hydrolysed alkoxysilanes, polyvinyl alcohol (PVOH) and polyethylene oxide. The thickness of the barrier layers described is 2 μm. The barrier action is achieved only after ageing or maturation of the laminate structure in a moist atmosphere at 40° C. over 4 days. The water temperature of 90° C. that is used in U.S. Pat. No. 7,157,147 B2 is generally inadequate for sterilization. A disadvantage of this process and the laminate produced according to the process is the required addition of phyllosilicates, since the process becomes more complex and the maintenance of a consistent film quality in mass production is made difficult.

U.S. Pat. No. 7,763,335 B2 discloses a multi-step process for producing laminate structures which maintain their barrier action against oxygen transmission even after 30 min of treatment with water at 120° C. in an autoclave. The process encompasses a formulation based on polyacrylic acid and alkoxysilanes, temperature control at 10° C., coating, drying for 5 min at 80° C., ageing or maturation of the laminate at 50° C. within 3 days, post-treatment for 5 min at 200° C., soaking for 20 s in an aqueous solution of calcium acetate at 80° C. and subsequent drying. The disadvantages of the described method lie in the complexity, in the long total duration of several days, in the individual steps which are difficult to realize in a roll-to-roll process and in high temperatures of up to 200° C., which commercially available and temperature-sensitive carrier films for food packaging cannot be exposed for longer than a few seconds or shorter.

US 2017/0009034 A1 discloses formulations composed of alkoxysilanes and polyvinyl alcohol which have a pH within the range from 1 to 3 under cooling of said formulations to 10° C. From said formulation, laminates are generated via a 2-stage drying of these layers within 30 s at 100° C. followed by 72 h at 85° C. The laminates thus produced maintain their barrier action against the transmission of oxygen even after 500 h of storage at 60° C. and 90% relative air humidity. However, for the production of sterilizable laminate structures, a disadvantage is that these barrier layers must be combined with aluminium oxide deposited from the gas phase. This requires the use of more complex equipment in production. A further disadvantage is that the post-treatment of the laminate in the form of a 2-stage drying requiring 3 days is necessary.

U.S. Pat. No. 7,560,168 B2 discloses the production of transparent barrier layers against oxygen transmission which maintain their barrier action even after 30 min of sterilization with hot water vapor at 121° C. (“retort treatment”). Production is carried out on the basis of hydrolysates of alkoxysilanes and of polymers having hydroxyl group, which are applied as barrier layer to an inorganic aluminium oxide layer previously deposited by means of a gas-phase process. The polymer with hydroxyl group that is used is polyvinyl alcohol. A disadvantage of this prior art is the need to first deposit on the plastics film an inorganic layer composed of aluminium oxide or silicon oxide with the aid of a gas-phase process from a vacuum before the barrier layer is applied.

A disadvantage when using inorganic oxide compounds, for example silicon oxide or aluminium oxide compounds, is the coating of the plastics film by means of technically complicated vacuum or gas-phase deposition processes, such as, for example, CVD (chemical vapor deposition), PVD (physical vapor deposition) and electron-beam evaporation, or likewise, in an additional process step when coating from a condensed phase, by means of technically complicated dispersion processes.

There is therefore a need for formulations and a process for the preparation thereof that make it possible to form with plastics films laminate structures which reduce to a minimum the transmission or the permeability or the diffusion of oxygen through said laminate structures even after water-vapor sterilization (retort treatment) has been carried out. In the context of the present invention, a minimum is understood to mean an oxygen transmission rate (OTR) of <4 cm³/m²/d/atm. Water-vapor sterilization (retort treatment) is understood to mean conditions of a relative air humidity >97% at temperatures >98° C. over a duration of at least 10 min. The formulation, its preparation and its use for the production of laminates having an OTR value<4 cm³/m²/d/atm is free of inorganic metal oxides, irrespective of whether said inorganic metal oxides could have been applied by means of a condensed phase, for example by dispersion, or by means of gas-phase deposition.

The object is achieved by a formulation comprising:

i) at least one hydrolysate of at least one compound of the formula (I)

RSi(OX)₃ (I)

where X are the same or different and are H, C1-C4-alkyl or acyl, R=OX, OH, C1-C4-alkyl or alkoxysilyl-substituted ethylene radical,

ii) at least one hydrolysate of at least one polyisocyanurate bearing alkoxysilylalkyl units,

iii) at least one polymer bearing hydroxyl groups, and

iv) an aqueous solvent mixture containing at least one alcohol having 1 to 4 carbon atoms, characterized in that the pH is from 1.8-4.7, preferably from 3-4.5, and the content of the polymer bearing hydroxyl groups is from 13% by weight to 33% by weight, based on the solids fraction of the formulation.

In the context of the present invention, hydrolysates are understood to mean the intermediates which arise from the hydrolysis of, for example, silicon-alkoxide bonds as well as their conversion products which are formed by condensation reactions, as is already disclosed in the prior art, for example in U.S. Pat. No. 7,531,243 B2, U.S. Pat. No. 7,157,147 B2, U.S. Pat. No. 7,763,335 B2, US 2017/0009034 A1 or U.S. Pat. No. 7,560,168 B2. When dissolved in alcohol/water mixtures, substances of the formula (I) RSi(OX)₃ form hydrolysates of the formula RSi(OH)₃ and/or polymeric condensation products having the structural units [RSi(OX)₂O_{1/2}]ₙ, n≥1, [RSi(OX)O]ₘ, m>1, [RSiO_{3/2}]ₖ, k>1, R=OH, H, O_{1/2}, alkyl, C₁₂N₃H₂₇[Si(OX)₃] or C₂H₄Si(OX)₃.

These structural units are, inter alia, detectable by means of ²⁹Si NMR spectroscopy, as already disclosed by US 2017/0009034 A1. These hydrolysates are unstable and are therefore to be considered especially as intermediates. They undergo condensation reactions with one another and thus form products of the formula [RSiO_{3/2}]ₖ, where k>1, R=O_{1/2}, OH, H, alkyl, C₁₂N₃H₂₇[Si(OX)₃], C₂H₄Si(OX)₃, and are referred to hereinafter as hydrolysate condensates. The aforementioned condensation reactions substantially take place in the barrier-forming layer on the plastics film and/or the barrier layer during the drying and post-treatment of the laminate structure, but also slowly in the formulation. Therefore, for the calculation of the compositions of the formulation and of the barrier layer, it is more practical not to use concentrations of the substances of the formula RSi(OX)₃, but to use instead concentrations of the corresponding hydrolysate condensates. For example, the concentration of the hydrolysate condensate SiO₂ (silicon dioxide) is calculated instead of the concentration of tetraalkoxysilane.

It may be advantageous when the formulation according to the invention comprises, preferably in its aqueous solvent mixture, at least one acid, preferably a non-volatile acid. In the context of the present invention, non-volatile acid is understood to mean an acid which is not separable, or is separable only in insignificant amounts, from the solvent mixture via the gas phase within a range from SATP conditions (“Standard Ambient Temperature T and Pressure P”, T=25° C. and P=1013 hPa) up to 100° C. under constant pressure.

Preferably, the non-volatile acid is selected from the group comprising phosphoric acid, maleic acid, malonic acid, acetylsalicylic acid, polyacrylic acid, sulfuric acid, their acid anhydrides or mixtures thereof.

It may be advantageous when the content of non-volatile acid in the formulation is within a range from 0.03% by weight to 3% by weight, preferably from 0.1% by weight to 1% by weight, particularly preferably from 0.2% by weight to 0.7% by weight, based on the solids fraction of the formulation.

The polyisocyanurate bearing alkoxysilylalkyl units preferably has the formula (II)

(R′—NCO)ₙ (II)

where n≥3, preferably n=3, and R′ is an alkylene radical having at least 3 carbon atoms, preferably having 3 carbon atoms, to which radical a trialkoxysilyl group, preferably a trimethoxysilyl group, has been bonded. Particularly preferably, the tris[3-(trimethoxysilyl)propyl] isocyanurate that is disclosed under the CAS registration No. 26115-70-8 is used in the formulation.

Advantageously, the content of the hydrolysate of the polyisocyanurate bearing alkoxysilylalkyl units of the formula (II) is from 1% by weight to 10% by weight, based on the solids fraction of the formulation.

The polymer bearing hydroxyl groups is preferably selected from the group comprising polyvinyl alcohols, ethylene-vinyl alcohol copolymers, wherein the hydrolysis level is with preference over 85%, preferably over 95%, and wherein the proportion of the ethylene units in the ethylene-vinyl alcohol copolymer is preferably less than 28% by weight, based on the mass of the ethylene-vinyl alcohol copolymer. Suitable polymers are commercially available, for example under the brand names Poval®, Mowiol®, Eval® and Exceval® from Kuraray, and Soarnol® from Nippon Gohsei. They differ in their molecular weight, hydrolysis level and ethylene content. In the context of the present invention, the hydrolysis level is understood to mean the proportion of free hydroxyl groups in the polymer bearing hydroxyl groups and is specified in the information from the manufacturer.

The content of the polymer bearing hydroxyl groups is preferably from 15% by weight to 25% by weight, particularly preferably from 17% by weight to 22% by weight, based on the solids fraction of the formulation.

The content of SiO₂, originating from a compound of the formula (I) where R=OX and X=C₁-C₄-alkyl, is preferably from 60% by weight to 90% by weight, preferably from 70% by weight to 85% by weight, particularly preferably from 75% by weight to 80% by weight, based on the solids fraction of the formulation. Advantageously, a compound of the formula (I) where X=C₁- or C₂-alkyl with corresponding R=OX is used.

It may also be advantageous when the content of the hydrolysate from a compound of the formula (I) where X=C₁-C₄-alkyl and R=OH, C₁-C₄-alkyl or alkoxysilyl-substituted ethylene radical is up to 20% by weight, preferably from 0.05% by weight to 15% by weight, particularly preferably from 1% by weight to 10% by weight, based on the solids fraction of the formulation.

The present invention further provides a process for preparing the formulation according to the invention, characterized by the steps:

a) providing at least:

a1) one compound containing alkoxysilyl units of the formula (I) as defined above,

a2) one polyisocyanurate bearing alkoxysilylalkyl units of the formula (II) as defined above,

a3) one polymer bearing hydroxyl groups as defined above,

a4) one aqueous solvent mixture containing at least one alcohol having 1 to 4 carbon atoms,

a5) one non-volatile acid, its acid anhydride or mixtures thereof;

b) contacting the reactants mentioned under a1)-a5) to form the formulation, wherein the contact time is from 1 min to 5 h, the temperature is at least 16° C. and the pH is within a range from 1.8-4.7, preferably from 3-4.5.

The present invention further provides a laminate structure having at least 2 layers comprising:

i) the formulation according to the invention in at least one of its disclosed embodiments and

ii) a substrate having a glass transition temperature Tg>60° C., preferably Tg>90° C., which is free of inorganic oxide layers from gas-phase deposition processes.

In the context of the present invention, a substrate is understood to mean a plastics film, especially transparent plastics films, having a glass transition temperature Tg>60° C., preferably Tg>90° C. Particular preference is given to plastics films based on polyesters, for example polyethylene terephthalate (PET).

Advantageous laminates or laminate structures have transparent substrates. It is likewise advantageous when the substrate has been coated from both sides, i.e. the front side and reverse side or the top side and bottom side of the substrate, with the formulation according to the invention.

The laminate structure according to the invention is distinguished by the fact that it has an oxygen transmission rate OTR of up to a maximum of 4 cm³/m²/d/atm after water-vapor sterilization has been carried out, i.e. after “retort treatment” has been carried out.

The present invention further provides a process for producing a laminate structure, comprising the following steps:

a) providing the formulation according to the invention in accordance with at least one of its disclosed embodiments;

b) providing a substrate;

c) optionally activating the substrate;

d) coating the substrate with the formulation mentioned under a), preferably on both sides of the substrate;

e) performing a first post-treatment with energy input, preferably as thermal treatment;

f) performing a second post-treatment under the conditions of a water-vapor sterilization.

Optionally, the substrate or the plastics film can be pretreated or activated in order to improve the adhesion of the barrier layer resulting from the formulation. Suitable as activation methods are, in particular, plasma treatment, corona treatment, dielectric barrier discharge (DBD) or UV radiation with ozone. The coating of the substrate or of the plastics film with the formulation according to the invention is done using conventional coating methods. Non-restrictive examples that can be mentioned are coating methods with doctor blade, slot die coating, roller coating, gravure coating, spray-coating methods and immersion-coating methods.

The first step of the post-treatment is preferably done thermally, preferably as a drying step, preferably directly after coating; preferably, drying with hot air or a hot fan is carried out. Drying can also be part of the subsequent second post-treatment step. The thermal post-treatment step is preferably carried out at temperatures from 100 to 320° C., preferably from 120° C. to 300° C.

The first post-treatment step can also be achieved by energy input from other sources such as electron beam, plasma or microwave radiation or a combination thereof.

An advantage of the process according to the invention for producing a laminate structure is that it does not comprise a process step in which a gas-phase deposition is effected.

It will be apparent and is the intention that all embodiments disclosed herein in connection with the formulations described are equally applicable to the processes and products described, and vice versa. Such embodiments likewise fall within the scope of the present invention.

The examples which follow are intended to elucidate the subject-matter of the present invention in detail, without having any limiting effect.

### Working Example 1I (According to the Invention)

Barrier-forming layers are produced from a formulation. The formulation consists of the mixture of the stock solutions (A), (B), (C) and (D) as follows:

Stock solution (A): 5% by weight SiO₂ solution prepared from 500 mg of acetic acid (100%), 17.9 g of tetraethoxysilane, 10 g of isopropyl alcohol, 71.6 g of water. To this end, 10 g of isopropyl alcohol, 11.6 g of water, 500 mg of acetic acid are initially charged, 17.9 g of tetraethoxysilane are added dropwise thereto within 4 h under intense stirring and the remaining 60 g of water are added. Thereafter, the solution is matured for a further hour. The pH of the solution is checked with indicator paper and is within the range from 3.5 to 4.1.

Stock solution (B): 5% by weight PVOH solution prepared from 5 g of Kuraray® Poval®-60-98, 90 g of water and 5 g of isopropyl alcohol.

Stock solution (C): 5% by weight solution of the hydrolysate condensate of 1,3,5-tris(3-trimethoxysilylpropyl) isocyanurate (calculated as hydrolysate condensate C₁₂N3H275i304.5) prepared from 7.5 g of 1,3,5-tris(3-trimethoxysilylpropyl) isocyanurate corresponding to the CAS registration No. 26115-70-8, 46.2 g of water, 46.2 g of isopropyl alcohol and 500 mg of acetic acid.

Stock solution (D): 4% by weight solution of phosphoric acid in water.

The coating formulation is mixed from the stock solutions in a weight ratio, based on the solids fraction, A:B:C:D=78:20:2:0.5.

The formulation is coated on both sides of the 50 μm PET film, activated beforehand with UV/ozone, by means of an automatic film applicator equipped with a 12 μm spiral doctor blade, and each side is dried at 100° C. for 1 min after coating. Thereafter, the PET film containing the barrier-forming layers on both sides is converted at 140° C. for 20 h into a barrier film or laminate structure. The oxygen transmission rate OTR of said laminate structure at 23° C. and 90% relative air humidity is less than 0.1 cm³/m²/d/atm. A second part of said laminate structure is treated at 99° C. and 98% relative air humidity for 16 h for the purposes of sterilization (“retort treatment”). The oxygen transmission rate of this sterilized barrier film at 23° C. and 90% relative air humidity is less than 0.4 cm³/m²/d/atm.

### Working Example 2I (According to the Invention)

Like Working Example 1, but the formulation for the coating with the barrier-forming layer is mixed from the stock solutions in a weight ratio, based on the solids fraction, A:B:C:D=74:20:6:0.5. The pH is within a range from 3.5 to 4.1.

The oxygen transmission rate OTR of said laminate structure at 23° C. and 90% relative air humidity is less than 0.1 cm³/m²/d/atm. A second part of said laminate structure is treated at 99° C. and 98% relative air humidity for 16 h for the purposes of sterilization (“retort treatment”). The oxygen transmission rate of said laminate structure at 23° C. and 90% relative air humidity is less than 0.8 cm³/m²/d/atm.

### Working Example 3I (According to the Invention)

Like Working Example 1, but the formulation for the coating with the barrier-forming layer is mixed from the stock solutions in a weight ratio, based on the solids fraction, A:B:C:D=75:16:9:0.25. The pH is within a range from 3.5 to 4.1.

The oxygen transmission rate OTR of said laminate structure at 23° C. and 90% relative air humidity is less than 0.1 cm³/m²/d/atm. A second part of said laminate structure is treated at 99° C. and 98% relative air humidity for 16 h for the purposes of sterilization (“retort treatment”). The oxygen transmission rate OTR of said laminate structure at 23° C. and 90% relative air humidity is 1.3 cm³/m²/d/atm.

### Working Example 4I (According to the Invention)

Like Working Example 1, but the formulation for the coating with the barrier-forming layer is mixed from the stock solutions in a weight ratio, based on the solids fraction, A:B:C:D=74:20:6:0. The pH is within a range from 3.5 to 4.1.

The oxygen transmission rate OTR of said laminate structure at 23° C. and 90% relative air humidity is less than 0.1 cm³/m²/d/atm. A second part of said laminate structure is treated at 99° C. and 98% relative air humidity for 16 h for the purposes of sterilization (“retort treatment”). The oxygen transmission rate OTR of said laminate structure at 23° C. and 90% relative air humidity is 4 cm³/m²/d/atm.

### Working Example 5I (According to the Invention)

Like Example 1, but 500 mg of 0.4% by weight hydrochloric acid was used in the stock solution (A) instead of 500 mg of acetic acid and the preparation of the solution took less than 30 min. The pH of the solution was checked with indicator paper and was within the range from 2.9 to 3.5. The stock solutions formulation according to the invention was, in a weight ratio, based on the solids fraction, A:B:C:D=78:20:2:0.5, immediately processed after its preparation, i.e. after a contact time of 1 min, for coating a PET film according to Working Example 1.

The oxygen transmission rate OTR of said laminate structure at 23° C. and 90% relative air humidity is less than 0.1 cm³/m²/d/atm. A second part of said laminate structure is treated at 99° C. and 98% relative air humidity for 16 h for the purposes of sterilization (“retort treatment”). The oxygen transmission rate OTR of said laminate structure at 23° C. and 90% relative air humidity is 0.9 cm³/m²/d/atm.

### Working Example 6I (According to the Invention)

Like Working Example 1, but the formulation for the coating with the barrier-forming layer is mixed from the stock solutions in a weight ratio, based on the solids fraction, A:B:C:D=73:20:7:0.25. The pH is within a range from 3.5 to 4.1.

The oxygen transmission rate OTR of said laminate structure at 23° C. and 90% relative air humidity is less than 0.1 cm³/m²/d/atm. A second part of said laminate structure is treated at 99° C. and 98% relative air humidity for 16 h for the purposes of sterilization (“retort treatment”). The oxygen transmission rate OTR of said laminate structure at 23° C. and 90% relative air humidity is 2 cm³/m²/d/atm.

### Working Example 7I (according to the Invention)

Like Working Example 1, but the formulation for the coating with the barrier-forming layer is mixed from the stock solutions in a weight ratio, based on the solids fraction, A:B:C:D=75:18:7:0.25. The pH is within a range from 3.5 to 4.1.

The oxygen transmission rate OTR of said laminate structure at 23° C. and 90% relative air humidity is less than 0.1 cm³/m²/d/atm. A second part of said laminate structure is treated at 99° C. and 98% relative air humidity for 16 h for the purposes of sterilization (“retort treatment”). The oxygen transmission rate OTR of said laminate structure at 23° C. and 90% relative air humidity is 2 cm³/m²/d/atm.

### Working Example 8I (according to the Invention)

A 5% by weight solution of polyacrylic acid in water was prepared as stock solution E. The coating formulation was mixed from the stock solutions in a weight ratio, based on the solids fraction, A:B:C:E=78:19:2:1.

Coating and post-treatment is done as in the preceding working examples. The oxygen transmission rate of the resultant sterilized barrier film is, at 23° C. and 90% relative air humidity, less than 3 cm³/m²/d/atm.

### Comparative Example 1C

Analogous to Working Example 1, but 500 mg of hydrochloric acid containing 10% by weight HCl are used in each case in the stock solutions (A) and (C) instead of 500 mg of acetic acid (100%). Preparation took less than 30 minutes, the pH of the stock solutions is <2. The formulation for the coating is mixed from the stock solutions in a weight ratio, based on the solids fraction, A:B:C:D=78:20:2:0. The pH of the formulation used for the coating of a PET film according to Working Example 1 is within a range from 1.5-2.1.

The oxygen transmission rate OTR of said laminate structure at 23° C. and 90% relative air humidity is less than 0.1 cm³/m²/d/atm. A second part of said laminate structure is treated at 99° C. and 98% relative air humidity for 16 h for the purposes of sterilization (“retort treatment”). The oxygen transmission rate OTR of said laminate structure at 23° C. and 90% relative air humidity is 22 cm³/m²/d/atm.

### Comparative Example 2C

Analogous to Working Example 1, but the formulation for the coating is mixed from the stock solutions in a weight ratio, based on the solids fraction, A:B:C:D=74:20:6:1. The pH is within a range from 3.5 to 4.1.

The oxygen transmission rate OTR of said laminate structure at 23° C. and 90% relative air humidity is less than 0.1 cm³/m²/d/atm. A second part of said laminate structure is treated at 99° C. and 98% relative air humidity for 16 h for the purposes of sterilization (“retort treatment”). The oxygen transmission rate OTR of said laminate structure at 23° C. and 90% relative air humidity is 13 cm³/m²/d/atm.

### Comparative Example 3C

Analogous to Working Example 1, but the formulation for the coating is mixed from the stock solutions in a weight ratio, based on the solids fraction, A:B:C:D=58:40:2:0.4. The pH is within a range from 3.5 to 4.1.

The oxygen transmission rate OTR of said laminate structure at 23° C. and 90% relative air humidity is less than 0.1 cm³/m²/d/atm. A second part of said laminate structure is treated at 99° C. and 98% relative air humidity for 16 h for the purposes of sterilization (“retort treatment”).

The oxygen transmission rate OTR of said laminate structure at 23° C. and 90% relative air humidity is 23 cm³/m²/d/atm.

### Comparative Example 4C

Analogous to Working Example 1, but the formulation for the coating is mixed from the stock solutions in a weight ratio, based on the solids fraction, A:B:C:D=88:10:2:0.4. The pH is within a range from 3.5 to 4.1.

The oxygen transmission rate OTR of said laminate structure at 23° C. and 90% relative air humidity is less than 0.1 cm³/m²/d/atm. A second part of said laminate structure is treated at 99° C. and 98% relative air humidity for 16 h for the purposes of sterilization (“retort treatment”). The oxygen transmission rate OTR of said laminate structure at 23° C. and 90% relative air humidity is 20 cm³/m²/d/atm.

The following table combines the results of the inventive and the comparative examples.

| | Proportion in | | | | | |
|---|---|---|---|---|---|---|
| | formulation | | | | | |
| | of stock solution | | | | | |
| | | | | D or E | | OTR after |
| | | | | if (E) | | retort |
| | | | | has been | | treatment |
| Example | A | B | C | specified | pH | [cm³/m²/d/atm] |
| 1I | 78 | 20 | 2 | 0.5 | 3.8 ± 0.3 | 0.4 |
| 2I | 74 | 20 | 6 | 0.5 | 3.8 ± 0.3 | 0.8 |
| 3I | 75 | 16 | 9 | 0.25 | 3.8 ± 0.3 | 1.3 |
| 4I | 74 | 20 | 6 | 0 | 3.8 ± 0.3 | 4 |
| 5I | 78 | 20 | 2 | 0.5 | 3.2 ± 0.3 | 0.9 |
| 6I | 73 | 20 | 7 | 0.25 | 3.8 ± 0.3 | 2 |
| 7I | 75 | 18 | 7 | 0.25 | 3.8 ± 0.3 | 2 |
| 8I | 78 | 19 | 2 | 1 (E) | 3.8 ± 0.3 | 3 |
| 1C | 78 | 20 | 2 | 0 | 1.8 ± 0.3 | 22 |
| 2C | 74 | 20 | 6 | 1 | 3.8 ± 0.3 | 13 |
| 3C | 58 | 40 | 2 | 0.4 | 3.8 ± 0.3 | 23 |
| 4C | 88 | 10 | 2 | 0.4 | 3.8 ± 0.3 | 20 |

The object set at the start of providing a formulation, the use of which makes it possible to produce laminate structures which have an oxygen transmission rate OTR<4 cm³/m²/d/atm after a water-vapor sterilization (“retort treatment”), is possible without use of inorganic metal oxides, especially those requiring a gas-phase deposition.

Relevant or critical features of the formulation according to the invention are the at least one hydrolysate of at least one polyisocyanurate bearing alkoxysilylalkyl units, especially that which is disclosed under the CAS registration No. 261155-70-8, and a pH from 1.8-4.7, preferably 3-4.5. The laminate structures according to the invention that are produced therefrom can be produced in a simplified manner compared to the prior art and exhibit acceptable values for the oxygen transmission rate OTR even after a water-vapor sterilization (“retort treatment”), meaning that use as packaging material is possible, for example for foodstuffs and pharmaceutical products.

1. A formulation comprising:
i) at least one hydrolysate of at least one compound of the formula (I)
RSi(OX)₃ (I)
where X are the same or different and are H, C₁-C₄-alkyl or acyl, R=OX, OH, C₁-C₄-alkyl or alkoxysilyl-substituted ethylene radical,
ii) at least one hydrolysate of at least one polyisocyanurate bearing alkoxysilylalkyl units,
iii) at least one polymer bearing hydroxyl groups, and
iv) an aqueous solvent mixture containing at least one alcohol having 1 to 4 carbon atoms,
wherein the pH is within a range from 1.8-4.7, and that the content of the polymer bearing hydroxyl groups is from 13% by weight to 33% by weight, based on the solids fraction of the formulation.

2. The formulation according to claim 1, wherein the formulation comprises at least one non-volatile acid.

3. The formulation according to claim 2, wherein the non-volatile acid is selected from the group consisting of phosphoric acid, maleic acid, malonic acid, acetylsalicylic acid, polyacrylic acid, sulfuric acid, their acid anhydrides or mixtures thereof.

4. The formulation according to claim 2, wherein the content of non-volatile acid is within a range from 0.03% by weight to 3% by weight, based on the solids fraction of the formulation.

5. The formulation according to claim 1, wherein the polyisocyanurate bearing alkoxysilylalkyl units is represented by the formula (II)
(R′—NCO)ₙ (II)
where n≥3, wherein R′ is an alkylene radical having at least 3 carbon atoms, to which radical a trialkoxysilyl group, has been bonded.

6. The formulation according to claim 5, wherein the content of the hydrolysate of the polyisocyanurate bearing alkoxysilylalkyl units of the formula (II) is from 1% by weight to 10% by weight, based on the solids fraction of the formulation.

7. The formulation according to claim 1, wherein the polymer bearing hydroxyl groups is selected from the group consisting of polyvinyl alcohols, ethylene-vinyl alcohol copolymers, wherein the hydrolysis level is over 85%, and wherein the proportion of the ethylene units in the ethylene-vinyl alcohol copolymer is less than 28% by weight, based on the mass of the ethylene-vinyl alcohol copolymer.

8. The formulation according to claim 1, wherein the content of SiO₂, originating from a compound of the formula (I) where
X=C₁-C₄-alkyl and R=OX, is within a range from 60% by weight to 90% by weight, based on the solids fraction of the formulation.

9. The formulation according to claim 1, wherein the content of a hydrolysate from the compound of the formula (I) where X=C₁-C₄-alkyl and R=OH, C₁-C₄-alkyl or alkoxysilyl-substituted ethylene radical is up to 20% by weight, based on the solids fraction of the formulation.

10. The formulation according to claim 1, wherein the content of the polymer bearing hydroxyl groups is from 15% by weight to 25% by weight, based on the solids fraction of the formulation.

11. The process for preparing a formulation according to claim 1, characterized by the steps:
a) providing at least:
a1) one compound containing alkoxysilyl units of the formula (I),
a2) one polyisocyanurate bearing alkoxysilylalkyl units of the formula (II),
a3) one polymer bearing hydroxyl groups,
a4) one aqueous solvent mixture containing at least one alcohol having 1 to 4 carbon atoms,
a5) one non-volatile acid, its acid anhydride or mixtures thereof;
b) contacting the reactants mentioned under a1)-a5) to form the formulation,
wherein the contact time is from 1 min to 5 h, the temperature is at least 16° C. and the pH is within a range from 1.8-4.7.

12. The laminate structure having at least 2 layers comprising:
i) the formulation according to claim 1 and
ii) a substrate having a glass transition temperature Tg>60° C., which is free of inorganic oxide layers from gas-phase deposition processes.

13. The laminate structure according to claim 12, wherein the substrate is transparent.

14. The laminate structure according to claim 12, wherein the substrate has been coated from both sides with the formulation.

15. The laminate structure according to claim 12, wherein the laminate structure has an oxygen transmission rate of up to a maximum of 4 cm³/m²/d/atm after retort treatment.

16. The process for producing a laminate structure according to claim 12, wherein it comprises the steps:
a) providing a formulation,
b) providing a substrate,
c) optionally activating the substrate,
d) coating the substrate with the formulation mentioned under a), preferably on both sides of the substrate,
e) performing a first post-treatment with energy input and
f) performing a second post-treatment under the conditions of a water-vapor sterilization.

17. The process according to claim 16, wherein it does not comprise a process step in which a gas-phase deposition is effected.

18. The formulation according to claim 1, wherein the pH is within a range from 3-4.5.

19. The formulation according to claim 2, wherein the content of non-volatile acid is within a range from 0.1% by weight to 1% by weight based on the solids fraction of the formulation.

20. The formulation according to claim 1, wherein the polyisocyanurate bearing alkoxysilylalkyl units is represented by the formula (II)
(R′—NCO)ₙ (II)
where n=3, wherein R′ is an alkylene radical having 3 carbon atoms to which a trimethoxysilyl group, has been bonded.
